(19) United States
(12) Patent Application Publication
(10) Pub. No.: US 2004/0153411 A1
(43) Pub. Date: Aug. 5, 2004

(54) Method and device for transferring secure information

(75) Inventors: Pascal Viger, Coesmes (FR); Emmanuel Raguet, Le Rheu (FR)

Correspondence Address: FITZPATRICK CELLA HARPER & SCINTO, 30 ROCKEFELLER PLAZA, NEW YORK, NY, 10112, US

(73) Assignee: Canon Europa N.V., Amstelveen (NL)

(21) Appl. No.: 10/758,024

(22) Filed: Jan. 16, 2004

(30) Foreign Application Priority Data
Jan. 16, 2003 (FR) 0300451

(51) Int. Cl. G06F 17/60

(52) U.S. Cl. 705/51

(57) ABSTRACT

The invention concerns a method and device for transferring at least one digital signal representing media content data in a communication network, the network comprising a client server device connected to at least one client station, at least one destination server device connected to at least one destination station wherein, when the client station receives a request to transfer a digital signal intended for at least one destination station, the client server device:

obtains a first encryption key further to the transfer request;

obtains the digital signal;

encodes said digital signal with the first encryption key obtained;

encodes the first encryption key with a second encryption key associated with the destination server device connected to the corresponding destination station;

transfers the encoded digital signal to said destination server device;

transfers the encoded first encryption key to said destination server device.

### BACKGROUND OF THE INVENTION

The present invention concerns a method and device for transferring secure information between terminals in a public communication network.

More particularly the public communication network is of Internet type.

In the conventional communication model using secret key cryptography, two people wishing to communicate by means of a non-secure communication channel must first agree upon a secret enciphering key K. The enciphering function and the deciphering function use the same key K.

This key exchange makes the information exchange more complex for an inexperienced user.

The concept of public key cryptography was invented by Whitfield Diffie and Martin Hellman in 1976. Public key cryptography makes it possible to solve the problem of key distribution through a non-secure channel. The principle of public key cryptography consists of using a pair of keys, a public key used for enciphering and a private key used for deciphering. A person A wishing to communicate information to a person B uses the public enciphering key of person B. Person B possesses the private key associated with his public key. Only person B is therefore capable of deciphering the message sent to him.

The person who has communicated the information does not have any guarantee as regards the future use of this information by the person who has received the information. Once the information has been decoded, this person can transfer this information to third parties without the person who has communicated the information being informed thereof or having given his permission.

The patent U.S. Pat. No. 5,812,671 describes a cryptographic communication system in which two conversing parties use a trusted third party for the exchange of encryption keys/methods belonging to each of them, thus avoiding the disclosure of keys/methods between the two conversing parties.

However, the two parties have full access to the data exchanged once they have been received and decrypted. The necessity of using a trusted third party makes the exchange more complex to manage.

The published American patent application 20010042045 describes a secure system for displaying digital data. In this patent application, the information is accessible only by means of a browser having only copying and selection capabilities.

This system has a guarantee as regards the future use of this information by the person who has received the information but requires the use of dedicated browsers.

The patent U.S. Pat. No. 6,098,056 describes a system allowing the securing of data during transport, and control of the disclosure of this data at the client. In order to guarantee control of access to the data, a trusted element is proposed in the information communication chain. This method requires the use of at least three pairs of secret/public keys (one for the sender, one for the client and one for the trusted element), manipulated many times in order to convey the secret key for enciphering of the protected data. This model is based on a context of commercial data exchange between several people, with a permanent Internet connection.

Suited to a fixed infrastructure, requiring a large number of information exchanges between the various participants who must be permanently connected to the communication network, this system is not desirable for Peer to Peer type networks.

A Peer to Peer type network is a network in which the machines communicate directly and from equal to equal, with no interposition of a server.

### SUMMARY OF THE INVENTION

The aim of the present invention is to remedy the problems mentioned above and to propose a method for secure transfer of information in a public network and more particularly in a Peer to Peer type network in which the users are connected to the public network by means of a server device with which they are associated. The Peer to Peer network is implemented between the server devices with which the clients are associated.

To that end, the invention proposes a method transferring at least one digital signal representing media content data in a communication network, the network comprising a client server device connected to at least one client station, at least one destination server device connected to at least one destination station wherein, when the client station receives a request to transfer a digital signal intended for at least one destination station, the client server device:

obtains a first encryption key further to the transfer request;

obtains the digital signal;

encodes said digital signal with the first encryption key obtained;

encodes the first encryption key with a second encryption key associated with the destination server device connected to the corresponding destination station;

transfers the encoded digital signal to said destination server device;

transfers the encoded first encryption key to said destination server device.

Correspondingly, the invention proposes a device for transferring at least one digital signal representing media content data in a communication network, the network comprising a client server device connected to at least one client station, at least one destination server device connected to at least one destination station wherein, the client station receiving a request to transfer a digital signal intended for at least one destination station, the client server device comprises:

means for obtaining a first encryption key further to the transfer request;

means for obtaining the digital signal;

means for encoding said digital signal with the first encryption key obtained;

means for encoding the first encryption key with a second encryption key associated with the destination server device connected to the corresponding destination station;

means for transferring the encoded digital signal to said destination server device;

means for transferring the encoded first encryption key to said destination server device.

Thus, the secure transfer takes place with no intervention of the client station and its user, the client server device performing all the operations necessary for the transfer of the document in a secure manner.

Furthermore, the fact of transmitting the encoded signal to the destination server device associated with the destination station or stations and not to the destination station or stations will guarantee the use of the encoded signal, and thus avoid an undesired use of the encoded signal.

This will facilitate the encoding of the document in particular if the client station transmits the document to multiple destination stations. This is because a single encoding of the document will be necessary, the key which has been used for the encoding will itself be encoded with a second key associated with each server device.

This avoids the server generating as many keys as destination servers and encoding the same information as many times as there are destination servers.

The security of the transmission will be assured, and the time necessary for the encoding will remain small by virtue of this provision.

More precisely, the client server device also determines, from the transfer request, whether information representing at least one restriction on use associated with a destination station exists and, if so, encodes the information representing at least one restriction with the second key associated with the destination server device of the corresponding destination station and transfers the encoded information to the destination server device. The information representing at least one restriction forms part of the group of restrictions on the duration of authorization for the display of the at least one digital signal by the destination station, the storage of the at least one digital signal by the destination station and for the printing of the at least one digital signal by the destination station

Thus, it is then possible to restrict the subsequent use of the said document by the destination station, and to guarantee inviolability, by the fact that it is encrypted and that only the destination server, and not the destination device, performs the decoding.

According to a variant, the transfer of the encoded signal to the said destination station is made by means of a centralized server device.

This makes it possible, when the destination server device cannot be contacted, to nevertheless transmit the information to a centralized server device which will transfer the information at the appropriate time. The client server device is then freed from this task.

Preferably, the first key is a secret key and the second key is a public key associated with the destination server device.

According to another aspect, the invention proposes a method of transferring at least one first digital signal representing media content data and which has been encoded using a first encryption key, in a communication network, the network comprising a client server device, and at least one destination server device connected to at least one destination station, wherein, when the client server device transfers the at least one digital signal encoded with the first encryption key to the at least one destination server device connected to the at least one destination terminal, the destination server device:

stores the signal transmitted by the client server device;

obtains the first encryption key by decoding, by means of a second key, a message received from the client server device,

decodes the stored digital signal by means of the first encryption key, and

transfers at least one second decoded digital signal representing a sub-part of the first digital signal representing media content data to at least one destination station.

The invention also proposes a device for transferring at least one first digital signal representing media content data and which has been encoded using a first encryption key, in a communication network, the network comprising a client server device, and at least one destination server device connected to at least one destination station, wherein, the client server device transferring the at least one digital signal encoded with the first encryption key to the at least one destination server device connected to the at least one destination terminal, the destination server device comprises:

means for storing the signal transmitted by the client server device;

means for obtaining the first encryption key by decoding, by means of a second key, a message received from the client server device,

means for decoding the stored digital signal by means of the first encryption key, and

means for transferring at least one second decoded digital signal representing a sub-part of the first digital signal representing media content data to at least one destination station.

Thus, the destination server device, having the coded digital signal available, will be able to retransmit it to any other client station associated therewith.

This makes it possible to guarantee that only the destination server device is able to decode the digital signal.

More particularly, the first digital signal representing media content data is at a first resolution and the destination server device also determines whether information representing at least one restriction has been transferred by the client server device and, if so, generates the second decoded digital signal at a resolution lower than the first resolution of the first digital signal representing media content data.

Thus, whatever the subsequent use of the second digital signal is, either copying or printing or some other use will not affect the security associated with the first digital signal.

Inviolability is managed by means of the destination server before even the destination device has had access to the first digital signal.

More particularly, on reception of a request to transfer the signal transmitted by the client server device to another destination station not associated with the destination server device, the destination server device obtains a third key associated with the destination server device associated with the other destination station, encodes the first key with the third key and transfers the digital signal encoded with the first key and the first key encoded with the third key.

Thus, the client server device will be able to distribute the transmission of the digital signal to other destination servers and by the same means avoid one of the major problems of Peer to Peer networks, namely the fact that a station is not permanently connected to the network.

Furthermore, the digital signal, present on a plurality of sites, will be accessible more certainly since it is probable that, amongst all the sites accommodating the digital signal, at least one is connected to the network at the time it is wished to obtain this digital signal.

Furthermore, the encoding being performed with a third key guarantees the inviolability of the encoded signal.

According to a further aspect, the invention proposes a method for the transfer of at least one digital signal representing media content data in a communication network between a client module and at least one destination module, the modules being connected to the network, wherein when it receives a request to transfer the digital signal to at least one destination module, the client module:

obtains the digital signal;

obtains a first encryption key;

encodes the digital signal with the first encryption key;

obtains information for the restriction on the use of the digital signal by the destination module, for which the digital signal is intended to be sent;

encodes the first encryption key and the use restriction information with a second encryption key associated with the destination module;

transfers the encoded digital signal to the destination module;

transfers the first encryption key and the use restriction information encoded with the second encryption key to the destination module.

Correspondingly, the invention also relates to a device for transferring at least one digital signal representing media content data in a communication network between a client module and at least one destination module, the modules being connected to the network, wherein the client module receiving a request to transfer the digital signal to at least one destination module, the client module comprises:

means for obtaining the digital signal;

means for obtaining a first encryption key;

means for encoding the digital signal with the first encryption key;

means for obtaining information for the restriction on the use of the digital signal by the destination module, for which the digital signal is intended to be sent;

means for encoding the first encryption key and the use restriction information with a second encryption key associated with the destination module;

means for transferring the encoded digital signal to the destination module;

means for transferring the first encryption key and the use restriction information encoded with the second encryption key to the destination module.

According to yet another aspect, the invention concerns a method for the transfer of at least one first digital signal representing digital media content data and which has been encoded using a first encryption key, in a communication network between a client module and at least one destination module, the modules being connected to the network, wherein, when the client module transfers the encoded first digital signal to the destination module, the destination module:

stores the first digital signal encoded with the first key;

obtains the first key and information for the restriction on the use of the digital signal by the destination module, by decoding a message transmitted by the client module, with a second key associated with the destination module;

decodes the stored first digital signal with the first key, taking into account at least part of the use restriction information, into a second digital signal representing at least part of the first digital signal.

Correspondingly, the invention also relates to a device for transferring at least one first digital signal representing digital media content data and which has been encoded using a first encryption key, in a communication network between a client module and at least one destination module, the modules being connected to the network, wherein, the client module transferring the encoded first digital signal to the destination module, the destination module comprises:

means for storing the first digital signal encoded with the first key;

means for obtaining the first key and information for the restriction on the use of the digital signal by the destination module, by decoding a message transmitted by the client module, with a second key associated with the destination module;

means for decoding the stored first digital signal with the first key, taking into account at least part of the use restriction information, into a second digital signal representing at least part of the first digital signal.

The invention also relates to a computer program comprising one or more sequences of instructions able to implement the method when the program is loaded and executed in a computer.

The invention also relates to an information carrier, such as a floppy disk or a compact disk (CD), characterized in that it contains such a computer program.

The advantages of this device, this computer, this computer program and this information carrier are identical to those of the methods as briefly described above.

Other particular features and advantages of the invention will emerge further in the following description, given with reference to the accompanying drawings

### BRIEF DESCRIPTION OF THE DRAWINGS

FIG. 1 depicts a communication network in which the invention is executed;

FIG. 2 is a block diagram of a server device according to the invention;

FIG. 3 depicts an algorithm for selecting images with a view to secure transfer according to the invention;

FIG. 4 depicts an algorithm for encrypting images with a view to secure transfer according to the invention;

FIG. 5 depicts a first variant of an image decryption and transfer algorithm according to the invention;

FIG. 6 depicts a second variant of an image decryption and transfer algorithm according to the invention.

### DETAILED DESCRIPTION OF THE INVENTION

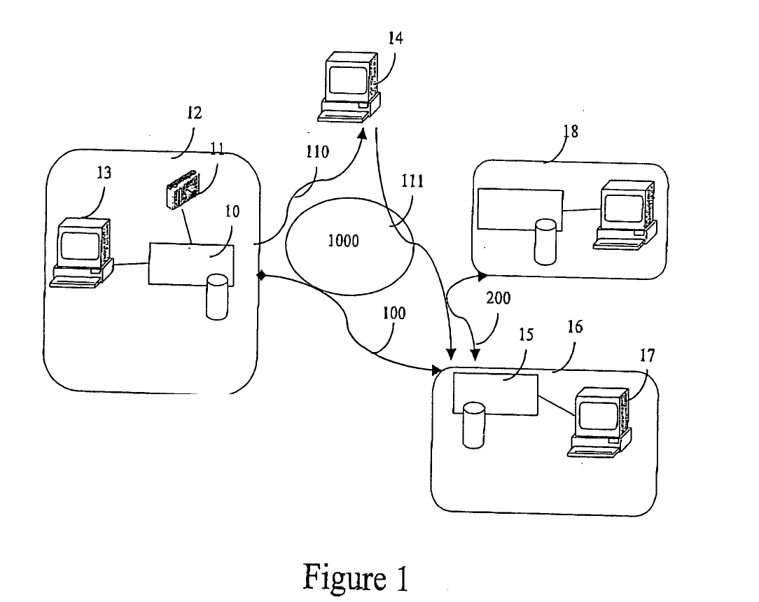

First of all, the communication network in which the invention is executed will be described with reference to FIG. 1.

This communication network consists of sub-networks 12, 16 and 18 which are conventionally local area networks placed for example in distant sites. By way of example, they are home local area networks consisting of at least one server 10 serving as a gateway between the stations of the said network and a public network referenced 1000 possibly being, for example, an Internet type network.

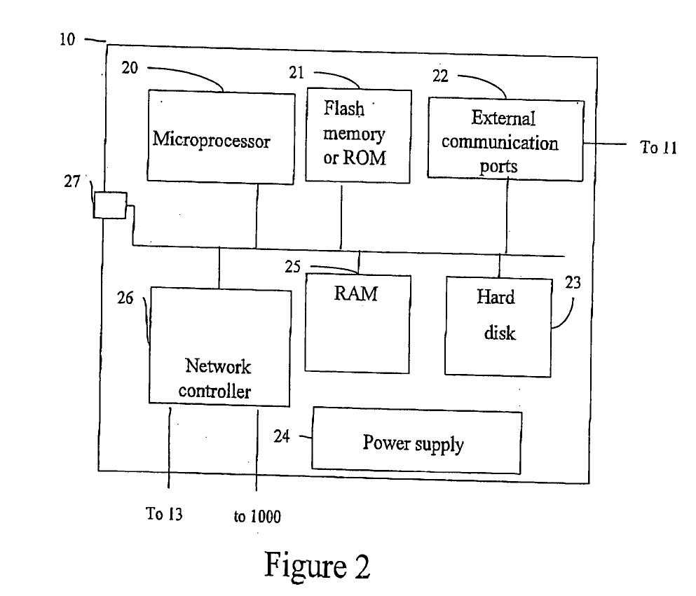

In this example, the sub-network 12 consists of a client server device 10 which will be described in more detail with reference to FIG. 2 and at least one client device 13 which is connected to the client server device 10.

The client server device 10 can be a PC type computer, or an image server device such as a decoder.

For reasons of clarity, a single client device 13 is depicted but it should be clearly understood that multiple client devices can be connected to the client server device.

The client device 13 is, for example, a PC type computer, a personal assistant, or some other device. According to one particular embodiment this must also comprise a conventional Internet browser.

Information processing and capture peripherals 11 can be connected to the client server device. These can be, for example, digital cameras, digital camcorders, or means for receiving information by satellite or radio channel. For reasons of clarity; these peripherals are represented by a single device referenced 11 in FIG. 1.

The sub-network 16 with a composition similar to the sub-network 12 also consists of at least one server device 15, which will subsequently be referred to as a client destination server, and at least one client destination device 17.

It should be clearly understood that subsequently, according to the direction of the exchanges between the sub-networks, a client server can be called a destination server, these being capable of implementing the invention for both secure information transmission and secure information reception.

The sub-network 18 will not be described in detail, it being similar to the sub-networks 12 and 16.

A central server 14 connected to the Internet network 1000 can, in a variant of the invention, play a part in the exchange of the secure information.

It can, for example, serve as an intermediary between the two sub-networks if, for example, the sub-network 16 is not connected to the public network 1000 at the time the client server sends it information.

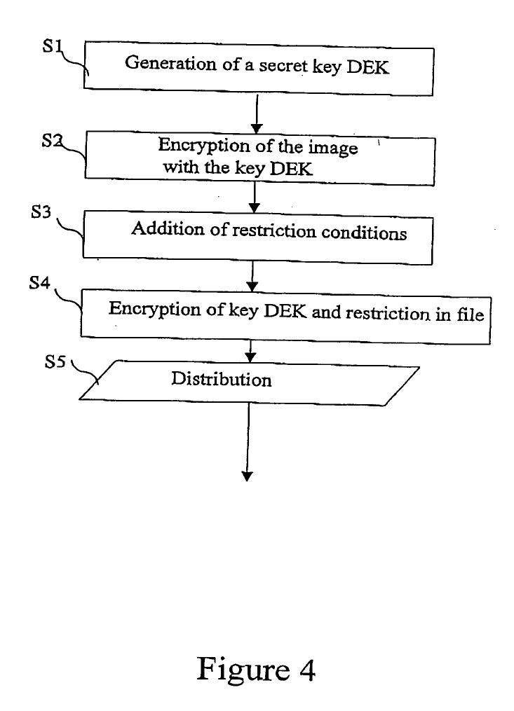

FIG. 2 depicts the client server device 10 or the destination server device 15 according to the invention. It comprises at least one microprocessor 20 responsible for executing in particular the algorithms described later with reference to FIGS. 4, 5 and 6.

The device 10 also comprises a RAM (Random Access Memory) volatile memory 25, which contains the instructions and registers allowing implementation of the image management method (or more generally media content data management method) in accordance with the invention.

The device comprises a memory accessible for reading 21 such as a Flash memory or ROM (Read Only Memory) containing the microprocessor operating program and the program responsible for starting up the device.

The device also comprises a network controller 26 allowing connection to a wired local area network (Ethernet card) or a wireless local area network (of type 802.11). Connection to the network will allow the client server device or destination server device to communicate with the client devices 13 or destination devices 17. This same network controller allows communication with the public Internet type network 1000.

The device comprises a hard disk 23 on which there will be stored the media content data to be transferred, in particular, the photographs uploaded from the camera 11, the media content data encrypted according to the algorithm of FIG. 4, the addresses of the destination servers, perhaps even the sub-addresses of the destination devices associated with the destination servers, the parameters or information limiting the use of the encrypted images, and the enciphering keys necessary for the information exchange.

Finally, the device comprises a power supply 24 ensuring the operation of all the members of the device, external communication ports 22 allowing connections to various peripherals such as an image processing apparatus 11 (a camera in the preferred embodiment), or a driver for a memory card of Flash card type for example.

The management device can also comprise signaling means 27, for example a flashing LED which will signal to the user that the encryption method is being implemented. When this LED is switched off, the user will be informed that he can remove the connected apparatus or the memory card.

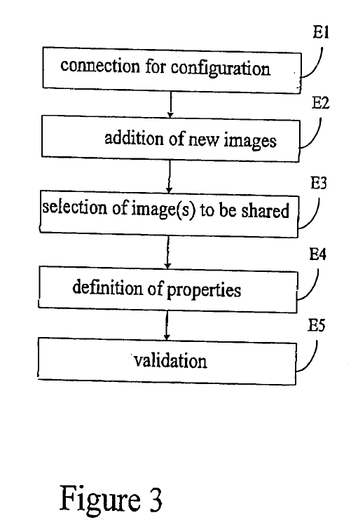

With reference now to FIG. 3, a description will be given of the algorithm implemented in the client station 13 for creating the transfer of information and more particularly of digital images, which the user of the client station wishes to share with other users of the network.

It should be noted that the digital signal representing media content data can also be a sound signal, the combination of a sound signal and digital images or more simply a document containing text.

The client station is a conventional device known to persons skilled in the art. It consists, for example, of a computer which comprises in its memory the code associated with the algorithm as described below.

The algorithm comprises five steps referenced E1 to E5.

The client station 13 has an Internet browser and, during the step E1, it will be connected by means of the Internet browser to the Internet server included in the client server 10 of the sub-network 12.

At the step E2, the user of the client device orders the loading of images contained in the memory of a digital camera 11 or of a memory card into the storage means 23 of the client server 10. Of course, if the images have been loaded previously, this step will not be performed.

It should be noted that the images can also be loaded first into the memory of the client device 13. This can be connected to a camera 11. In this case, the loaded images will subsequently be transferred to the storage means 23 of the destination server 10.

The central unit of the client station 13 next goes to the step E3, which consists of selecting, by means of conventional digital photograph album management software, at least one image which the user of the client station wishes to share with other users of the network and then this selection information is transferred to the Internet browser of the client server device.

The central unit of the client station next goes to the step E4, which consists of specifying the destination station or stations, for example the station 17 of FIG. 1, by their address or key words which will allow the client server 10 to identify the address of the destination device or devices.

According to a variant, the user at the same time communicates the public enciphering key of the destination server or servers 15 or 18 associated with the client destination or destinations to which it wishes to communicate the image.

During the step E4, the restrictions on use by a destination station are also recorded.

Amongst these, and non-limitatively, are restrictions on duration for the display of the shared image in terms of days, weeks or some other duration, on image quality mode authorized during the display or printing of the shared images or on the authorization by the destination device 17 for storing the shared image in whole or in part.

It should be noted here that the conditions of use can be defined uniquely for all destination devices but also for each destination device.

Where several destination devices are associated with the same destination server, there can be different restrictions for each destination device, such as for example: only the restriction related to storage can be associated with one destination device, only the restriction as regards display in a degraded quality can be associated with another destination device, and finally no display or storage possibility is authorized for another destination device.

Thus in one and the same home network, the users can have different data access rights. This thus guarantees the confidentiality of certain information between the users of one and the same home network.

Thus, as will be described later, a single transfer of information will be made to the destination server, and multiple client destinations can share this information, the security of the shared information being guaranteed even in the sub-network 16, for example.

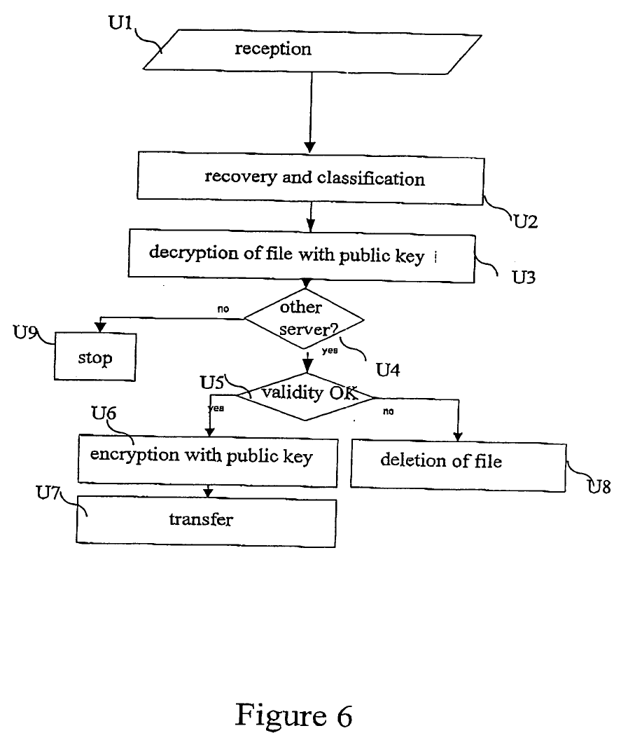

In the variant as described later with reference to FIG. 6, a single transfer will also be made to one of the destination servers with which destination stations are associated, this then providing transfer of the encrypted information to the other destination servers with which the other destination stations are associated. This further transfer is illustrated by the line 200 of FIG. 1.

These operations having been performed, the central unit of the client device will, at the step E5, await a validation from the microprocessor 20 of the client server 10 of the correct recording of the sharing properties and restrictions on use for terminating the program associated with the algorithm.

FIG. 4 depicts the algorithm in the memory 23 of the client server 10. The code or program representing this algorithm is loaded from the hard disk 23 into the RAM memory 25 and the instructions are executed by the microprocessor 20.

The algorithm consists of five steps referenced S1 to S5.

During the first step S1, the microprocessor 20, following a validation from the microprocessor 20 of the client server 10 of the correct recording of the sharing properties and restrictions on use for terminating the program associated with the algorithm described with reference to FIG. 3, will generate a secret key for encrypting the information to be transmitted.

This secret encryption key is generated, for example, in a random and conventional manner known to persons skilled in the art.

This generation having been performed, the microprocessor 20 will then, during the step S2, encrypt (or encode) the image or images with the secret key generated.

This operation having been performed, the microprocessor will, at the step S3, add the restriction conditions defined during execution of the algorithm of FIG. 3 associated with the transfer of information to be transferred. It should be noted that, if key words have been associated with the address of the destination device, the microprocessor 20 will obtain the address equivalent to these key words from the destination server associated with the destination device, perhaps even the sub-address of the destination device associated with the destination server if necessary.

If the address is unknown, the client server can, for example, automatically obtain these addresses by generating a call denoted 110 in FIG. 1 on the network 1000 to a central server 14 if this exists.

It should be noted that, during this step, the microprocessor 20 will obtain the public key or keys associated with the destination server or servers concerned with the transfer. This can be done by reading from the memory 23, by generation of a request 110 to the central server 14, or by a request 100 by means of the Internet network 1000 of FIG. 1 to the destination server concerned.

This operation having been performed, the microprocessor will then, at the step S4, encrypt the previously generated key DEK with the public key or keys associated with the destination servers. If restriction conditions as regards the display, storage or printing exist, these are also encrypted with the public key or keys.

It should be noted that, in the case of the variant as described later with reference to FIG. 6, the microprocessor will also, during this step, insert the address or addresses of the destination servers and their public key so as to provide in a simple manner all the data necessary for the destination server receiving this information for the further sending of this information to the other destination servers.

This is because this makes it possible to reduce the time necessary for the encryption of one or more images to be transferred. This is because a single encryption of the image is performed for possible multiple destinations.

This is because the encryption or encoding of images is much more costly in terms of time than that of a key simple key.

This operation having been performed, the microprocessor 20 next goes to the step S5 which consists of sending the encrypted images, the key DEK and the encrypted restrictions to the destination servers or to a single one in accordance with the variant described later with reference to FIG. 6 by means of the Internet network 1000. This is depicted by the link 100 in FIG. 1.

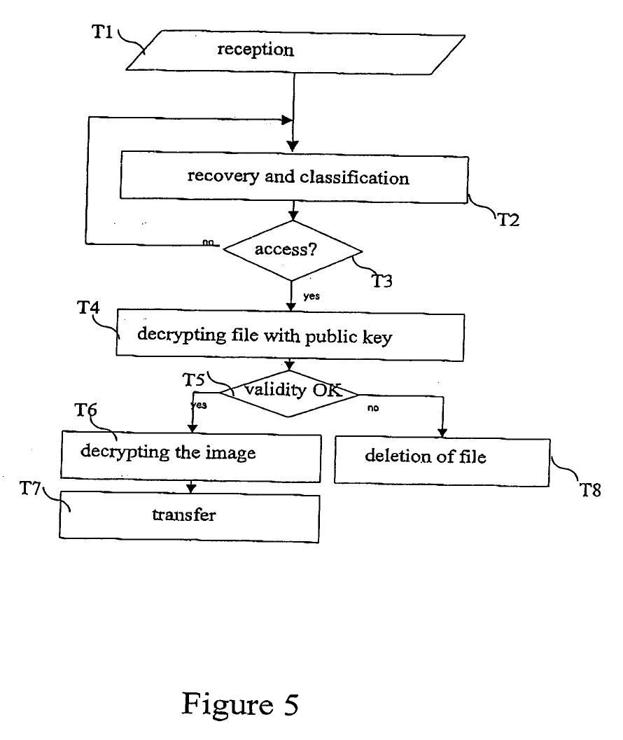

FIG. 5 depicts the algorithm in the memory 23 of the destination server 15. As explained previously, the destination server device is identical to the client server described with reference to FIG. 2.

The code or program representing this algorithm is loaded from the hard disk 23 into the RAM memory 25 and the instructions are executed by the microprocessor 20.

The algorithm consists of eight steps referenced T1 to T8.

At the first step T1, the microprocessor 20 receives the encrypted or encoded information transferred at the step S5 of the algorithm of FIG. 4.

At the step T2, the microprocessor 20 will transfer the received information from the temporary area of the Internet service (e-mail, on-line server, etc.) and classify it in a database in order to be used later at the request of a destination device 17. This database can consist for example of a photograph album. According to a variant, a notification can be sent to the user on the local area network in order to inform him of the availability of new shared images.

At the step T3, the microprocessor 20 will await a request for display by one of the destination devices associated with it of the shared images.

As long as an access request has not been received, the microprocessor will remain in the loop consisting of the steps T2 and T3.

If the answer is yes, the microprocessor 20 goes to the step T4. This step consists of decrypting, by means of the key SK, the key DEK and the restrictions which were previously classified and relate to the request from the user.

This action is possible by virtue of the secret key SK internal to the destination server device 16. This key is conventionally the secret key associated with the public key which has been used to encrypt the key DEK and the limitations.

The data thus recovered are: the unique key DEK, the image file encrypted with this key DEK, and the information on the duration of validity of disclosure and on the access method granted.

At the step T5, an analysis of this information follows, in particular a data validity search. If the data is analyzed as invalid (in terms of date), the microprocessor goes to the step T8 and will delete all this information.

If the data is valid, the processor 20 goes to the step T6 which consists of decrypting the image with the key DEK decrypted at the step T4.

The step T7 consists of verifying the form in which the image has to be offered to the client user, in such a way that the disclosure conditions chosen by the owner of the images are complied with, and of transferring said image to the destination device.

According to one particular embodiment, if restrictions exist, a lower quality image is transferred.

FIG. 6 depicts the algorithm in the memory 23 of the destination server 15. As explained previously, the destination server device is identical to the client server described with reference to FIG. 2.

The code or program representing this algorithm is loaded from the hard disk 23 into the RAM memory 25 and the instructions are executed by the microprocessor 20.

The algorithm consists of nine steps referenced U1 to U9.

At the first step U1, the microprocessor 20 receives the encrypted information transferred at the step S5 of the algorithm of FIG. 4.

At the step U2, the microprocessor 20 will transfer the received information from the temporary area of the Internet service (e-mail, on-line server, etc.) and classify it in a database in order to be used later at the request of a destination device 17. This database can consist for example of a photograph album. According to a variant, a notification can be sent to the user on the local area network in order to inform him of the availability of new shared images.

At the step U3, the microprocessor 20 will decrypt, by means of the key SK, the key DEK and the restrictions which were previously classified and relate to the request from the user.

This action is possible by virtue of the secret key SK internal to the destination server device 16. This key is conventionally the secret key associated with the public key which was used to encrypt the key DEK and the restrictions.

The data thus recovered are: the unique key DEK, the image file encrypted with this key DEK, and the information on the duration of validity of disclosure and on the access method granted.

At the step U4, the microprocessor 20 will determine whether there exists at least one destination device which is not associated with the destination server. That is to say, whether it has received a request for transfer of the signal by the client server device to another destination station not associated with the destination server. If the answer is no, the microprocessor 20 goes to the step U9 which is the end of the algorithm, or in a variant the central unit goes to the step T5 of FIG. 5.

If the answer is yes, the microprocessor goes to the step U5, which consists of analyzing the information, in particular a data validity search. If the data is analyzed as invalid (in terms of date), the microprocessor goes to the step U8 and will delete all this information.

In the affirmative, the microprocessor 20 goes to the step U6 which consists of encrypting the key DEK and the conditions of restrictions on use with a third key which is the public key associated with the destination server with which the destination device determined at the step U4 is associated.

It should be noted that this public key can be obtained in various ways. Either the public key has been transferred by one of the client servers 10 or the destination server of the sub-network 14 or the central server 18, or this key is already in the memory 23 of the destination server.

Finally, the microprocessor 20 goes to the step U7 which consists of transferring the information encrypted at the step U6 and the previously received information encrypted with the key DEK, bound for the destination server associated with the client destination determined at the step U4.

Of course, many modifications can be made to the embodiments of the invention described above without departing from the scope of the invention.

1. A method of transferring at least one digital signal representing media content data in a communication network, the network comprising a client server device connected to at least one client station, at least one destination server device connected to at least one destination station wherein, when the client station receives a request to transfer a digital signal intended for at least one destination station, the client server device:
obtains a first encryption key further to the transfer request;
obtains the digital signal;
encodes said digital signal with the first encryption key obtained;
encodes the first encryption key with a second encryption key associated with the destination server device connected to the corresponding destination station;
transfers the encoded digital signal to said destination server device;
transfers the encoded first encryption key to said destination server device.

2. A method according to claim 1, wherein the client server device also determines, from the transfer request, whether information representing at least one restriction on use by a destination station exists and, if so, encodes the information representing at least one restriction with the second key associated with the destination server device of the corresponding destination station and transfers the encoded information to the destination server device.

3. A method according to claim 1, wherein the said digital signal is stored in advance on the client server.

4. A method according to claim 1, wherein the transfer of the encoded signal to the said destination station is made by means of a centralized server device connected to the network.

5. A method according to claim 1, wherein the first key is a secret key and the second key is a public key associated with the destination server device.

6. A method according to claim 5, wherein the public key is obtained by reading a storage means of the client server device or by generating a request on the communication network to the centralized server device or the destination server device.

7. A method according to claim 2, wherein the information representing at least one restriction forms part of the group of restrictions on the duration of authorization for the display of the at least one digital signal by the destination station, the storage of the at least one digital signal by the destination station and the printing of the at least one digital signal by the destination station.

8. A method of transferring at least one first digital signal representing media content data and which has been encoded using a first encryption key, in a communication network, the network comprising a client server device, and at least one destination server device connected to at least one destination station, wherein, when the client server device transfers the at least one digital signal encoded with the first encryption key to the at least one destination server device connected to the at least one destination terminal, the destination server device:
stores the signal transmitted by the client server device;
obtains the first encryption key by decoding, by means of a second key, a message received from the client server device,
decodes the stored digital signal by means of the first encryption key, and
transfers at least one second decoded digital signal representing a sub-part of the first digital signal representing media content data to at least one destination station.

9. A method according to claim 8, wherein the first digital signal representing media content data is at a first resolution and in that the destination server device also determines whether information representing at least one restriction associated with at least one destination station has been transferred by the client server device and, if so, generates the second decoded digital signal at a resolution lower than the first resolution of the first digital signal representing media content data.

10. A method according to claim 9, wherein the destination server device also determines whether information representing the at least one restriction has been transferred by the client server device and, in the negative, the destination server device transfers the second digital signal representing the whole of the first digital signal.

11. A method according to claim 8, wherein, on reception of a request to transfer the signal transmitted by the client server device to another destination station not associated with the destination server device, the destination server device obtains a third key associated with the destination server device associated with the other destination station, encodes the first key with the third key and transfers the first digital signal encoded with the first key and the first key encoded with the third key.

12. A method for the transfer of at least one digital signal representing media content data in a communication network between a client module and at least one destination module, the modules being connected to the network, wherein when it receives a request to transfer the digital signal to at least one destination module, the client module:
obtains the digital signal;
obtains a first encryption key;
encodes the digital signal with the first encryption key;
obtains information for the restriction on the use of the digital signal by the destination module, for which the digital signal is intended to be sent;
encodes the first encryption key and the use restriction information with a second encryption key associated with the destination module;
transfers the encoded digital signal to the destination module;
transfers the first encryption key and the use restriction information encoded with the second encryption key to the destination module.

13. A method for the transfer of at least one digital signal according to claim 12, wherein the destination module comprises a destination server connected to the network and at least one destination client connected to the destination server.

14. A method for the transfer of at least one digital signal according to claim 13, wherein the second encryption key is associated with the destination server.

15. A method for the transfer of at least one digital signal according to claim 13, wherein the restriction use information comprises information for the restriction on the use of the digital signal by the at least one destination client, for which the digital signal is intended.

16. A method for the transfer of at least one digital signal according to claim 12, wherein the use restriction information comprises the specification of rights for copying or storing or reproducing or printing the at least one digital signal, the time validity of said rights, the specification of the resolution under which the digital signal should be accessed.

17. A method for the transfer of at least one digital signal according to claim 12, wherein the first key is a secret key, and the second key is a public key associated with the destination module.

18. A method for the transfer of at least one digital signal according to claim 17, wherein the public key is obtained by reading storage means of the client module or by generating a request on the communication network to a centralized server or to the destination module.

19. A method for the transfer of at least one digital signal according to claim 12, wherein the use restriction information comprises a request for the destination module to transfer the digital signal encoded with the first key to at least a second destination module.

20. A method for the transfer of at least one first digital signal representing digital media content data and which has been encoded using a first encryption key, in a communication network between a client module and at least one destination module, the modules being connected to the network, wherein, when the client module transfers the encoded first digital signal to the destination module, the destination module:
stores the first digital signal encoded with the first key;
obtains the first key and information for the restriction on the use of the digital signal by the destination module, by decoding a message transmitted by the client module, with a second key associated with the destination module;
decodes the stored first digital signal with the first key, taking into account at least part of the use restriction information, into a second digital signal representing at least part of the first digital signal.

21. A method for the transfer of at least one digital signal according to claim 20, wherein the destination module comprises a destination server connected to the network and at least one destination client connected to the destination server.

22. A method for the transfer of at least one digital signal according to claim 21, wherein at least part of the second digital signal is transferred to at least one of the destination stations.

23. A method for the transfer of at least one digital signal according to claim 21, wherein the second key is associated with the destination server.

24. A method for the transfer of at least one digital signal according to claim 21, wherein the restriction use information comprises information for the restriction on the use of the first digital signal by the at least one destination client, for which the digital signal is intended.

25. A method for the transfer of at least one digital signal according to claim 20, wherein the use restriction information comprises the specification of rights for copying or storing or reproducing or printing the at least one digital signal, the time validity of said rights, the specification of the resolution under which the digital signal should be accessed.

26. A method for the transfer of at least one digital signal according to claim 20, wherein upon reception of a request to transfer the first digital signal encoded with the first key to at least one second destination module, the destination module:
obtains a third key associated with the at least one second destination module;
encodes the first key and information for the restriction on the use of the at least one second destination module, with the third key;
transfers the first digital signal encoded with the first key to the destination module;
transfers the first key and use restriction information encoded with the third key to the at least one second destination module.

27. A device for transferring at least one digital signal representing media content data in a communication network, the network comprising a client server device connected to at least one client station, at least one destination server device connected to at least one destination station wherein, the client station receiving a request to transfer a digital signal intended for at least one destination station, the client server device comprises:
means for obtaining a first encryption key further to the transfer request;
means for obtaining the digital signal;
means for encoding said digital signal with the first encryption key obtained;
means for encoding the first encryption key with a second encryption key associated with the destination server device connected to the corresponding destination station;
means for transferring the encoded digital signal to said destination server device;
means for transferring the encoded first encryption key to said destination server device.

28. A device according to claim 27, wherein the client server device also comprises means for determining, from the transfer request, whether information representing at least one restriction on use by a destination station exists and means for encoding the information representing at least one restriction with the second key associated with the destination server device of the corresponding destination station and means for transferring the encoded information to the destination server device.

29. A device according to claim 27, wherein the device also comprises means for storing said digital signal.

30. A device according to claim 27, wherein the transfer of the encoded signal to the said destination station is made by means of a centralized server device connected to the network.

31. A device according to claim 27, wherein the first key is a secret key and the second key is a public key associated with the destination server device.

32. A device according to claim 31, wherein the means for obtaining the public key is adapted to obtain the key by reading a storage means of the client server device or by generating a request on the communication network to the centralized server device or the destination server device.

33. A device according to claim 28, wherein the information representing at least one restriction forms part of the group of restrictions on the duration of authorization for the display of the at least one digital signal by the destination station, the storage of the at least one digital signal by the destination station and the printing of the at least one digital signal by the destination station.

34. A device for transferring at least one first digital signal representing media content data and which has been encoded using a first encryption key, in a communication network, the network comprising a client server device, and at least one destination server device connected to at least one destination station, wherein, the client server device transferring the at least one digital signal encoded with the first encryption key to the at least one destination server device connected to the at least one destination terminal, the destination server device comprises:
means for storing the signal transmitted by the client server device;
means for obtaining the first encryption key by decoding, by means of a second key, a message received from the client server device,
means for decoding the stored digital signal by means of the first encryption key, and
means for transferring at least one second decoded digital signal representing a sub-part of the first digital signal representing media content data to at least one destination station.

35. A device according to claim 34, wherein the first digital signal representing media content data is at a first resolution and in that the destination server device also comprises means for determining whether information representing at least one restriction associated with at least one destination station has been transferred by the client server device and means for generating the second decoded digital signal at a resolution lower than the first resolution of the first digital signal representing media content data.

36. A device according to claim 35, wherein the destination server device also comprises means for determining whether information representing the at least one restriction has been transferred by the client server device and means for transferring the second digital signal representing the whole of the first digital signal.

36. A device according to claim 34, wherein, the destination server device receiving a request to transfer the signal transmifted by the dient server device to another destination station not associated with the destination server device, the destination server device comprises means for obtaining a third key associated with the destination server device associated with the other destination station, means for encoding the first key with the third key and means for transferring the first digital signal encoded with the first key and the first key encoded with the third key.

37. A device for transferring at least one digital signal representing media content data in a communication network between a client module and at least one destination module, the modules being connected to the network, wherein the client module receiving a request to transfer the digital signal to at least one destination module, the client module comprises:
means for obtaining the digital signal;
means for obtaining a first encryption key;
means for encoding the digital signal with the first encryption key;
means for obtaining information for the restriction on the use of the digital signal by the destination module, for which the digital signal is intended to be sent;
means for encoding the first encryption key and the use restriction information with a second encryption key associated with the destination module;
means for transferring the encoded digital signal to the destination module;
means for transferring the first encryption key and the use restriction information encoded with the second encryption key to the destination module.

38. A device for transferring at least one digital signal according to claim 37, wherein the destination module comprises a destination server connected to the network and at least one destination client connected to the destination server.

39. A device for transferring at least one digital signal according to claim 38, wherein the second encryption key is associated with the destination server.

40. A device for transferring at least one digital signal according to claim 38, wherein the restriction use information comprises information for the restriction on the use of the digital signal by the at least one destination client, for which the digital signal is intended.

41. A device for transferring at least one digital signal according to claim 37, wherein the use restriction information comprises the specification of rights for copying or storing or reproducing or printing the at least one digital signal, the time validity of said rights, the specification of the resolution under which the digital signal should be accessed.

42. A device for transferring at least one digital signal according to claim 37, wherein the first key is a secret key, and the second key is a public key associated with the destination module.

43. A device for transferring at least one digital signal according to claim 42, wherein the means for obtaining the public key is adapted to obtain the key by reading storage means of the client module or by generating a request on the communication network to a centralized server or to the destination module.

44. A device for transferring at least one digital signal according to claim 37, wherein the use restriction information comprises a request for the destination module to transfer the digital signal encoded with the first key to at least one second destination module.

45. A device for transferring at least one first digital signal representing digital media content data and which has been encoded using a first encryption key, in a communication network between a client module and at least one destination module, the modules being connected to the network, wherein, the client module transferring the encoded first digital signal to the destination module, the destination module comprises:
means for storing the first digital signal encoded with the first key;
means for obtaining the first key and information for the restriction on the use of the digital signal by the destination module, by decoding a message transmitted by the client module, with a second key associated with the destination module;
means for decoding the stored first digital signal with the first key, taking into account at least part of the use restriction information, into a second digital signal representing at least part of the first digital signal.

46. A device for transferring at least one digital signal according to claim 45, wherein the destination module comprises a destination server connected to the network and at least one destination client connected to the destination server.

47. A device for transferring at least one digital signal according to claim 46, wherein at least part of the second digital signal is transferred to at least one of the destination stations.

48. A device for transferring at least one digital signal according to claim 46, wherein the second key is associated with the destination server.

49. A device for transferring at least one digital signal according to claim 46, wherein the restriction use information comprises information for the restriction on the use of the first digital signal by the at least one destination client, for which the digital signal is intended.

50. A device for transferring at least one digital signal according to claim 45, wherein the use restriction information comprises the specification of rights for copying or storing or reproducing or printing the at least one digital signal, the time validity of said rights, the specification of the resolution under which the digital signal should be accessed.

51. A device for transferring at least one digital signal according to claim 45, wherein the destination module receiving a request to transfer the first digital signal encoded with the first key to at least one second destination module, the destination module comprises:
means for obtaining a third key associated with the at least one second destination module;
means for encoding the first key and information for the restriction on the use of the at least one second destination module, with the third key;
means for transferring the first digital signal encoded with the first key to th destination module;
means for transferring the first key and use restriction information encoded with the third key to the at least one second destination module.

52. An information carrier, possibly totally or partially removable, which can be read by a computer system, wherein it contains instructions of a computer program for implementing the transfer method according to claim 1.

53. A computer program stored on an information carrier, said program comprising instructions for implementing the transfer method according to claim 1 when it is loaded and executed by a computer system.

54. An information carrier, possibly totally or partially removable, which can be read by a computer system, characterized in that it contains instructions of a computer program for implementing a transfer method according to claim 8.

55. A computer program stored on an information carrier, said program comprising instructions for implementing the transfer method according to claim 8 when it is loaded and executed by a computer system.

56. An information carrier, possibly totally or partially removable, which can be read by a computer system, characterized in that it contains instructions of a computer program for implementing a transfer method according to claim 12.

57. A computer program stored on an information carrier, said program comprising instructions for implementing the transfer method according to claim 12 when it is loaded and executed by a computer system.

58. An information carrier, possibly totally or partially removable, which can be read by a computer system, characterized in that it contains instructions of a computer program for implementing a transfer method according to claim 20.

59. A computer program stored on an information carrier, said program comprising instructions for implementing the transfer method according to claim 20 when it is loaded and executed by a computer system.
